(19) United States
(12) Patent Application Publication
(10) Pub. No.: US 2008/0141933 A1
(43) Pub. Date: Jun. 19, 2008

(54) Semiconductor plating system for plating semiconductor object

(75) Inventors: Cha-jea Jo, Suwon-si (KR); Joong-hyun Baek, Suwon-si (KR); Hee-jin Lee, Seongnam-si (KR); Ku-young Kim, Seoul (KR); Ju-il Choi, Suwon-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 11/984,402

(22) Filed: Nov. 16, 2007

(30) Foreign Application Priority Data
Dec. 13, 2006 (KR) 10-2006-0127202

(51) Int. Cl. B05C 5/00

(52) U.S. Cl. 118/400

(57) ABSTRACT

Provided is a semiconductor plating system for plating a semiconductor object with a desired layer. The semiconductor plating system include a plating tank configured to accommodate a plating solution for use in plating the semiconductor object, and a plating solution induction device configured to induce the plating solution to spirally flow toward the semiconductor object.

### PRIORITY CLAIM

A claim of priority is made to Korean Patent Application No. 10-2006-0127202, filed on Dec. 13, 2006, in the Korean Intellectual Property Office, the disclosure of which is incorporated herein in its entirety by reference.

### BACKGROUND

1. Field

Example embodiments of the present invention may relate to a semiconductor plating system, and more particularly, to a semiconductor plating system for plating a layer on a semiconductor wafer to improve the uniformity of properties of the plating layer.

2. Description of the Related Art

In general, a semiconductor plating system is used to plate a semiconductor object, such as a semiconductor wafer, with a desired plating material such as copper. The metal layer is formed on the wafer by an electrochemical reaction, when a plating element contained in a plating solution between two electrodes is induced.

The semiconductor plating system is widely used because properties of a plated metal layer plated using this system has been better than those of a metal layer formed using other methods, for example, a chemical vapor deposition (CVD) process or a physical vapor deposition (PVD) process.

Referring to FIG. 1, a conventional semiconductor plating system includes a plating tank 1 and a plating solution supply pipe 2.

The plating tank 1 usually has a cylindrical shape with an open top portion. The plating tank 1 includes a plating solution space S in which a plating solution 4 for reacting with a semiconductor object 3, for example, a semiconductor wafer W, is accommodated. A plating solution outlet 1a is disposed through an upper circumferential surface of the plating tank 1.

The plating solution supply pipe 2 is installed through a bottom surface of the plating tank 1 and supplies the plating solution 4 to the plating solution space S.

The semiconductor object 3, for example, the semiconductor wafer W, is provided in the open top portion of the plating tank 1 and brought into contact with the plating solution 4.

In this arrangement, the semiconductor wafer W may be plated with a plating element of the plating solution 4, the plating element being induced by one electrode (not shown) installed under the plating tank 1 and the other electrode (not shown) installed at the top portion of the plating tank 1.

The plating solution 4 is supplied to the plating tank 1 through the plating solution supply pipe 2. After reacting with the semiconductor wafer W, the plating solution 4 may be discharged through the plating solution outlet 1a and re-circulated for another processes or for disposal.

The plating solution 4 is provided vertically upwards from the plating solution supply pipe 2, flows in a radial direction from a center of the semiconductor wafer W toward the edge thereof, and is discharged through the plating solution outlet 1a. However, in the conventional semiconductor plating system, the pressure of the plating solution 4 is concentrated on the center of the semiconductor wafer W as shown in FIG. 28. Thus, a difference K in velocity at the center and at an edge of the semiconductor wafer W may be as shown in FIG. 29. As a result, a plated thickness at the center and at the edge of the semiconductor wafer W may also be different as can be seen in FIG. 30, which is a false color image showing a plated thickness of the semiconductor wafer W. In addition, there is also a significant difference in the smoothness (e.g., evenness) of a plated layer at the center and at the edge of the semiconductor wafer W. The plated layer formed using the conventional semiconductor plating system has nonuniform properties.

More of the plating solution 4 flows to the center than to the edge of the semiconductor wafer W as can be seen in FIG. 28, which is a simulation of a flow analysis of the conventional semiconductor plating system. FIG. 29 is a graph showing the velocity of the plating solution 4 at the center of the semiconductor wafer W, and as can be seen, a difference K between the highest velocity and the lowest velocity is as much as 0.6 meters per second. Thus, as can be further seen in FIG. 30, there is a significant difference in the plated thickness between the center of the semiconductor wafer W and the edge thereof.

Referring to FIG. 1, in order to solve the above-described problems, a wafer rotation device 5 for rotating the semiconductor wafer W has been used. However, even if the semiconductor wafer W is rotated, it is still difficult to uniformly mass transfer the plating solution 4 onto the semiconductor wafer W. In particular, several power supplies for supplying power to the wafer rotation device 5 are required to drive the wafer rotation device 5, and the plating solution 4 may leak between the plating tank 1 and the wafer rotation device 5. Therefore, a rear surface of the semiconductor wafer W may be stained with the leaked plating solution, which may adversely affect subsequent processes.

There have been attempts to separately regulate the flow rates of a plurality of plating solution supply pipes to control the flow of a plating solution to a semiconductor wafer. These semiconductor plating systems require complicated and expensive apparatuses, and conditions under which a variety of apparatuses can operate together must be found by trial and error.

### SUMMARY

Example embodiments of the present invention may provide a semiconductor plating system that can improve the uniformity of properties (e.g., plated thickness, shape, and roughness) of a layer plated on a semiconductor object.

In an example embodiment of the present invention, a semiconductor plating system for plating a semiconductor object may include a plating tank configured to accommodate a plating solution for use in plating the semiconductor object, and a plating solution induction device configured to induce the plating solution to spirally flow toward the semiconductor object.

### BRIEF DESCRIPTION OF THE DRAWINGS

The above and other aspects of example embodiments may become more apparent explanation of the detail example embodiments of the present invention thereof with reference to the attached drawings in which:

FIG. 1 is a schematic view of a conventional semiconductor plating system;

FIG. 2 is a schematic view of a semiconductor plating system according to an example embodiment of the present invention;

FIG. 3 is a longitudinal sectional view of a plating solution spray nozzle shown in FIG. 2 according to an example embodiment of the present invention;

FIG. 4 is a cross sectional view of the plating solution spray nozzle taken along line IV-IV of FIG. 2 according to an example embodiment of the present invention;

FIG. 5 is a cross sectional view of another example embodiment of the plating solution spray nozzle shown in FIG. 2 according to an example embodiment of the present invention;

FIG. 6 is a cross sectional view of still another example embodiment of the plating solution spray nozzle shown in FIG. 2 according to an example embodiment of the present invention;

FIG. 7 is a cross sectional view of yet another example embodiment of the plating solution spray nozzle shown in FIG. 2 according to an example embodiment of the present invention;

FIG. 8 is a cross sectional view of another example embodiment of the plating solution spray nozzle shown in FIG. 2 according to an example embodiment of the present invention;

FIG. 9 is a cross sectional view of yet still another example embodiment of the plating solution spray nozzle shown in FIG. 2 according to an example embodiment of the present invention;

FIG. 10 is a longitudinal sectional view of another example embodiment of the plating solution spray nozzle shown in FIG. 3 according to an example embodiment of the present invention;

FIG. 11 is a longitudinal sectional view of another example embodiment of the plating solution spray nozzle shown in FIG. 10 according to an example embodiment of the present invention;

FIG. 12 is a plan view of the plating solution spray nozzle shown in FIG. 11 according to an example embodiment of the present invention;

FIG. 13 is a schematic view of a semiconductor plating system according to another example embodiment of the present invention;

FIG. 14 is a schematic view of a semiconductor plating system according to yet another example embodiment of the present invention;

FIG. 15 is a schematic view of a semiconductor plating system according to still another example embodiment of the present invention;

FIG. 16 is a perspective view of an example of a propeller shown in FIG. 15 according to an example embodiment of the present invention;

FIG. 17 is a plan view of the propeller shown in FIG. 16 according to an example embodiment of the present invention;

FIG. 18 is a schematic view of a semiconductor plating system according to another example embodiment of the present invention;

FIG. 19 is a schematic view of a semiconductor plating system according to another example embodiment of the present invention;

FIG. 20 is a perspective view of an example embodiment of a propeller shown in FIG. 19 according to an example embodiment of the present invention;

FIG. 21 is a schematic view of a semiconductor plating system according to another example embodiment of the present invention;

FIG. 22 is a plan view showing a control state of the semiconductor plating system shown in FIG. 21 according to an example embodiment of the present invention;

FIG. 23 is a schematic view of a semiconductor plating system according to another example embodiment of the present invention;

FIG. 24 is a schematic view of a semiconductor plating system according to another example embodiment of the present invention;

FIG. 25 is a schematic view of a semiconductor plating system according to another example embodiment of the present invention;

FIG. 26 is a schematic view showing the spiral flow and instantaneous velocity coordinates of a plating solution induced by a semiconductor plating system according to an example embodiment of the present invention;

FIG. 27 is a perspective view of an example of a plating solution spray nozzle according to an example embodiment of the present invention;

FIG. 28 is a flow analysis diagram showing the flow of a plating solution when using a conventional semiconductor plating system;

FIG. 29 is a graph showing the velocity of a plating solution with respect to a distance from the center of a semiconductor wafer in a conventional semiconductor plating system;

FIG. 30 is a false color image showing thickness distribution of a semiconductor wafer that is plated using a conventional semiconductor plating system;

FIG. 31 is a flow analysis diagram showing a flow of a plating solution when using a semiconductor plating system according to an example embodiment of the present invention;

FIG. 32 is a graph showing the velocity of a plating solution with respect to a distance from the center of a semiconductor wafer in a semiconductor plating system according to an example embodiment of the present invention; and

FIG. 33 is a false color image showing thickness distribution of a semiconductor wafer that is plated using a semiconductor plating system according to an example embodiment of the present invention.

### DETAILED DESCRIPTION

A semiconductor plating system according to example embodiments of the present invention will now be described more fully hereinafter with reference to the accompanying drawings, in which example embodiments of the present invention are shown.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-section illustrations that may be schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to limit the example embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

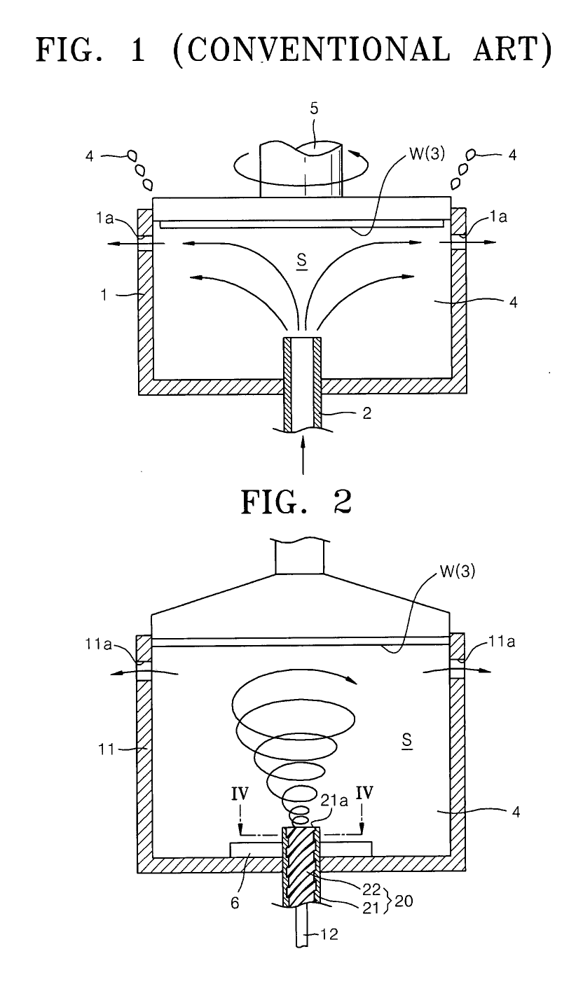

Referring to FIG. 2, a semiconductor plating system according to an example embodiment of the present invention may include a plating tank 11 and a plating solution induction device 20.

The plating tank 11 may include a plating solution space S in which a plating solution 4 for plating a semiconductor object 3, e.g., a semiconductor wafer W, is accommodated. The plating tank 11 may have a cylindrical shape with an open top portion. Also, a plating solution supply pipe 12 may be disposed through a center of a bottom surface of the plating tank 11, a plating solution outlet 11a may be formed through an upper circumferential surface of the plating tank 11, and an electrode 6 may be installed near the plating solution supply pipe 12.

The plating solution induction device 20 may be used to spirally induce the flow of the plating solution 4. Thus, even if a semiconductor wafer W is fixed to the open top portion of the plating tank 11, a plated layer formed on the semiconductor wafer W may have better uniform properties.

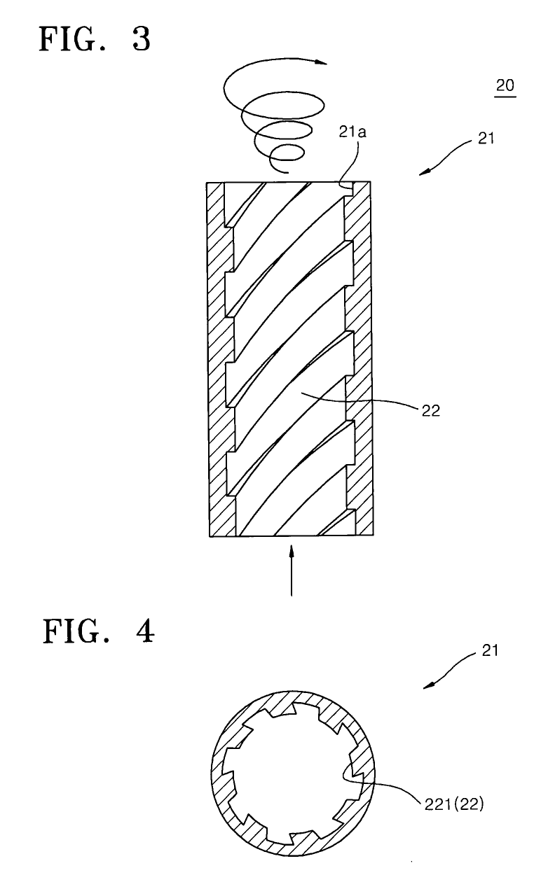

The plating solution induction device 20 may induce the plating solution 4 to spirally flow to the semiconductor object 3. Referring to FIGS. 2 and 3, the plating solution induction device 20 may be a plating solution spray nozzle 21, which may have an elongated shape. The plating solution spray nozzle 21 may be vertically oriented with respect to the semiconductor object 3. The plating solution spray nozzle 21 may include an output orifice 21a and spiral induction channels (protrusions) 22 disposed on an inner surface of the output orifice 21a.

Referring to FIG. 4, the spiral induction protrusions 22 may be lozenge-shaped protrusions 221 having a cross section that is formed to slightly lean in one direction.

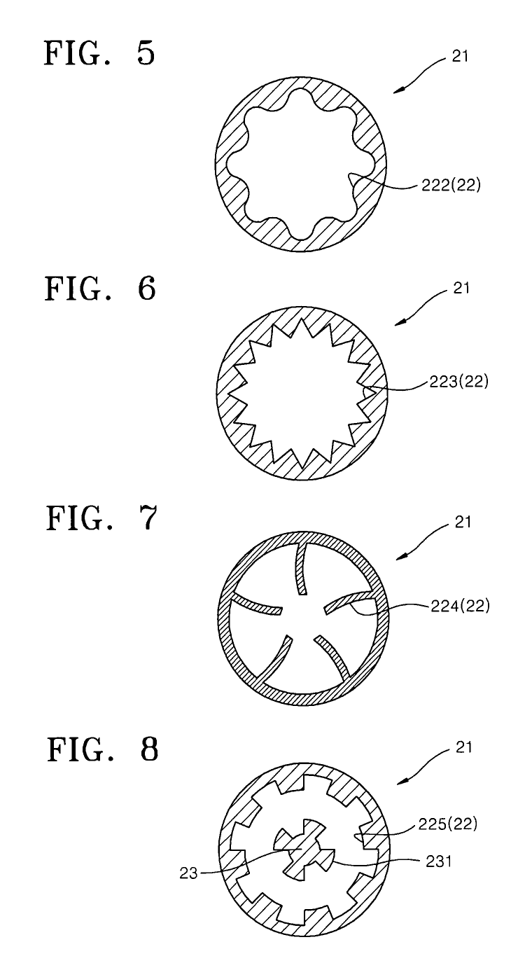

In addition, the spiral induction protrusions 22 may be rounded protrusions 222 having a round section as shown in FIG. 5, triangular protrusions 223 having a triangular section as shown in FIG. 6, elongated bent plate protrusions 224 having a curved section as shown in FIG. 7, or square protrusions 225 having a square section as shown in FIG. 8. It will be obvious to a person of ordinary skill that the spiral induction protrusions 22 may have other shapes and sizes, so long as the spiral induction protrusions 22 can induce the plating solution 4 to spiral.

Therefore, in the semiconductor plating system according to example embodiments of the present invention as shown in FIG. 2, the plating solution 4 passes through the plating solution spray nozzle 21 and is guided by the spiral induction protrusions 22 and spirally sprayed. Thus, even though the plating solution 4 keeps flowing spirally by inertia, the plating solution 4 may spread in a radial direction along a surface of the semiconductor wafer W and discharge through the plating solution outlet 11a.

Referring to FIG. 8, according to an example embodiment of the present invention, the plating solution spray nozzle 21 may include a spiral rod 23 having spiral induction protrusions 231. In this structure, the plating solution 4, which is provided through the plating solution spray nozzle 21, is induced not only by the spiral induction protrusions 22 (225) but also by the spiral induction protrusions 231 of the spiral rod 23. As a result, the plating solution 4 may flow in a tighter spiral in the plating tank 11.

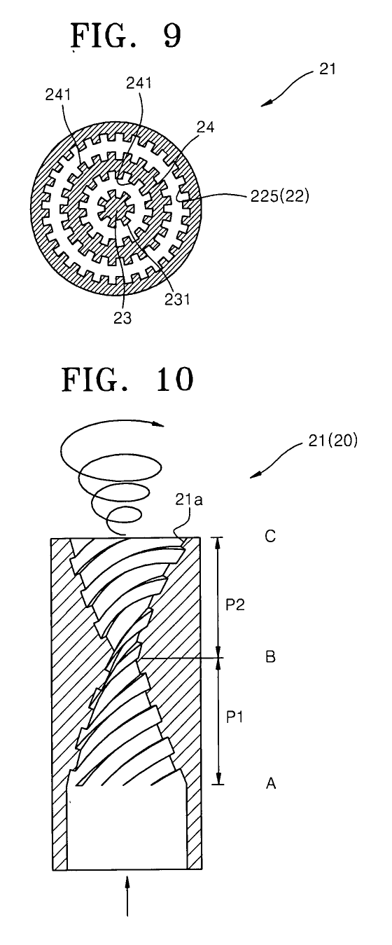

Referring to FIG. 9, an internal nozzle 24 may be further installed between the plating solution spray nozzle 21 and the spiral rod 23. Spiral induction protrusions 241 may be formed on both inner and outer surfaces of the internal nozzle 24. In this structure, movement of the plating solution 4 through the plating solution spray nozzle 21 may be induced by the spiral induction protrusions 22, the spiral induction protrusions 231 of the spiral rod 23, and the spiral induction protrusions 241 formed on both the inner and outer surfaces of the internal nozzle 24. As a result, the plating solution 4 may flow in a greater and tighter spiral in the plating tank 11.

Referring to FIG. 10, in order to facilitate the induction of the spiral flow of the plating solution 4, the plating solution spray nozzle 21 may include a narrowing portion P1 and a widening portion P2. Here, “narrowing” and “widening” means a diameter of the opening narrows and widens with respect to the flow of the plating solution, respectively. In other words, the diameter of the narrowing portion P1 is gradually reduced to increase the pressure of the plating solution 4 passing through the narrowing portion P1. On the other hand, the diameter of the widening portion P2 is gradually increased to decrease the pressure of the plating solution 4 passing through the widening portion P2.

FIG. 10 illustrates that the diameter of each of the narrowing portion P1 and the widening portion P2 varies in proportion to a distance by which the plating solution 4 flows.

Therefore, when the plating solution 4 passes through the narrowing portion P1 of the plating solution spray nozzle 21, the pressure of the plating solution 4 increases, so that the plating solution 4 flows at a high rate. Then, when the plating solution 4 is flowing through the widening portion P2, the pressure of the plating solution 4 decreases and the flow of the plating solution 4 expands towards the spiral induction protrusions 22 and is induced to the vicinity of the spiral induction protrusions 22. Thus, the spiral flow of the plating solution 4 may be facilitated.

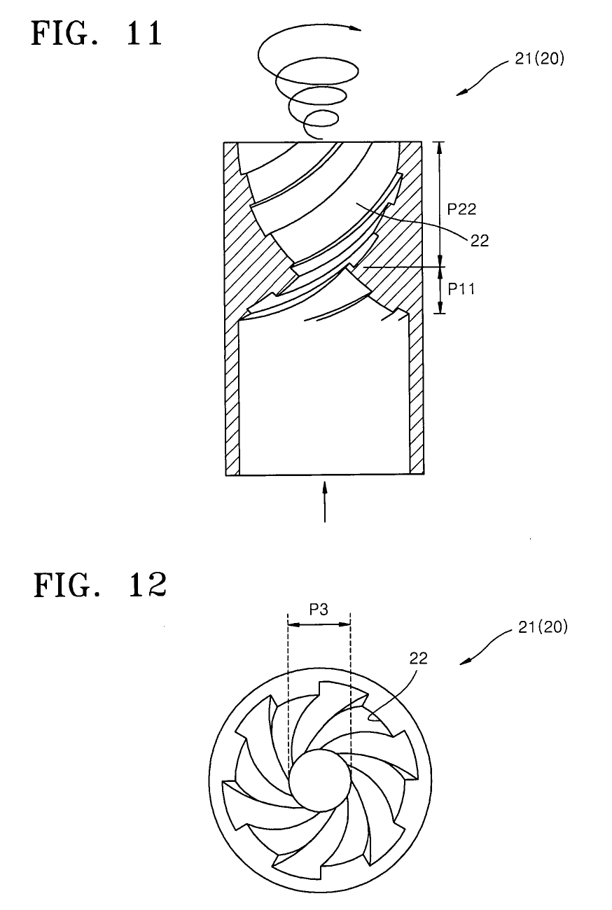

Referring to FIGS. 11 and 12, the diameter of a narrowing portion P11 of the plating solution spray nozzle 21 may suddenly decrease and then decrease gradually, and the diameter of a widening portion P22 may suddenly increase and then gradually decrease. In other words, the increase in the narrowing portion P11 and the decrease in the widening portion are exponential.

In this case, the pressure of the plating solution 4 in the narrowing portion P11 can increase at a higher rate, and the pressure of the plating solution 4 in the widening portion P22 can decrease at a higher rate.

A variation in the diameter of the narrowing portion P11 and a variation in the diameter of the widening portion P22 may be adjusted based on a narrowing port P3 to control the flow of the plating solution 3.

The above-described spiral induction protrusions 22 may be formed using a screw cutting process or a screw forming process.

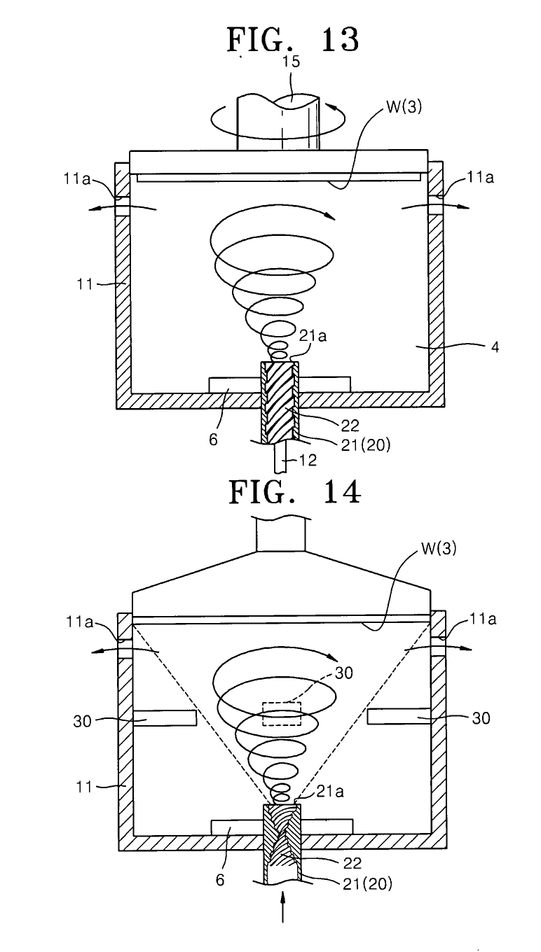

Referring to FIG. 13, a semiconductor plating system according to another example embodiment of the present invention may optionally include a wafer rotation device 15 installed in the open top portion of the plating tank 11 to rotate the semiconductor wafer W. As illustrated in FIG. 13, while the plating solution 4 spirally flows in the plating tank 11, the semiconductor wafer W may rotate in the same direction as the plating solution 4 or rotate in a reverse direction thereto.

Referring to FIG. 14, a semiconductor plating system according to another example embodiment of the present invention may further include a cut-off member 30, which may be installed in the plating tank 11 to partially cut off the spiral flow of the plating solution 4 in the plating tank 11.

For example, if the spiral flow of the plating solution 4 in the plating tank 11 is too fast near the center of the semiconductor wafer W and is too slow near the edge of the semiconductor wafer W, the cut-off member 30 may be disposed in a middle portion of the plating tank so that the flow of the plating solution 4 may be controlled.

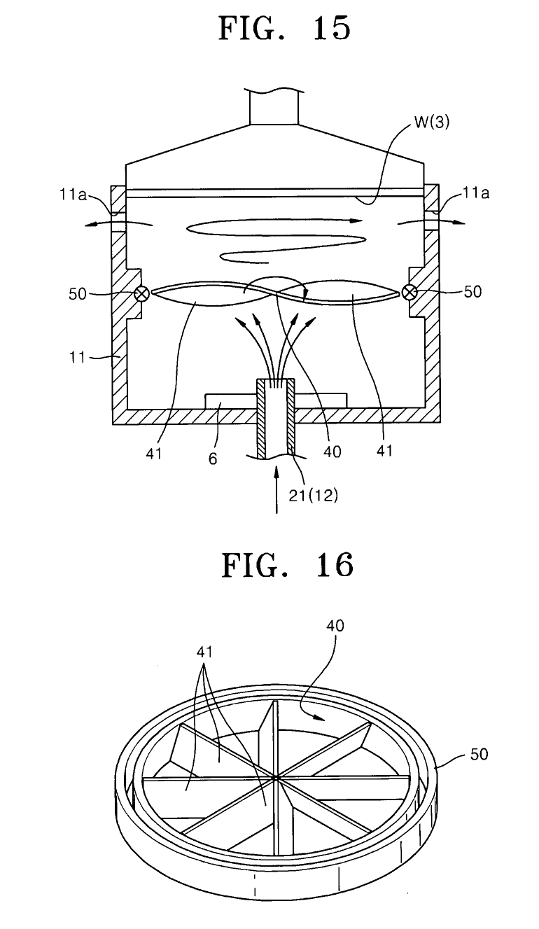

Referring to FIG. 15, a semiconductor plating system according to another example embodiment of the present invention may employ a propeller 40 installed in the plating tank 11 as the plating solution induction device 20.

The propeller 40 may be installed using a bearing 50 such that the propeller 40 is capable of rotating the flow of the plating solution 4.

Thus, the plating solution 4 vertically ejects through the plating solution supply pipe 2 and collides with inclined blades 41 of the propeller 40 to rotate the propeller 40. The propeller 40 is affected by the moment of inertia and continues to rotate, which further induces the plating solution 4 to spiral.

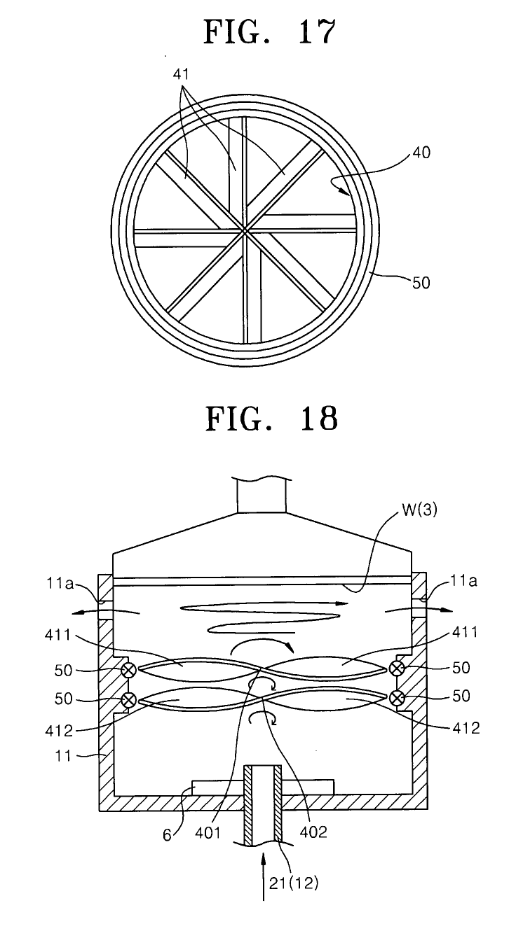

The above-described propeller 40 may be installed in the plating tank 11 using the bearing 50 such that the propeller 40 is capable of freely rotating. As illustrated in FIGS. 15 and 16 the propeller 40 may include the inclined blades 41 that are radially arranged and inclined in a direction, as illustrated in FIG. 17.

The shape and number of the inclined blades 41 may be varied.

Referring to FIG. 18, a semiconductor plating system according to another example embodiment of the present invention may include at least two propellers 401 and 402. The propeller 401 may be a forward propeller having forward blades 411, and the propeller 402 may be a reverse propeller having reverse blades 412. The forward and backward propellers 401 and 402 may be installed approximate to each other.

By use of the at least two propellers 401 and 402, the spiral flow of the plating solution 4 may be more precisely induced and controlled.

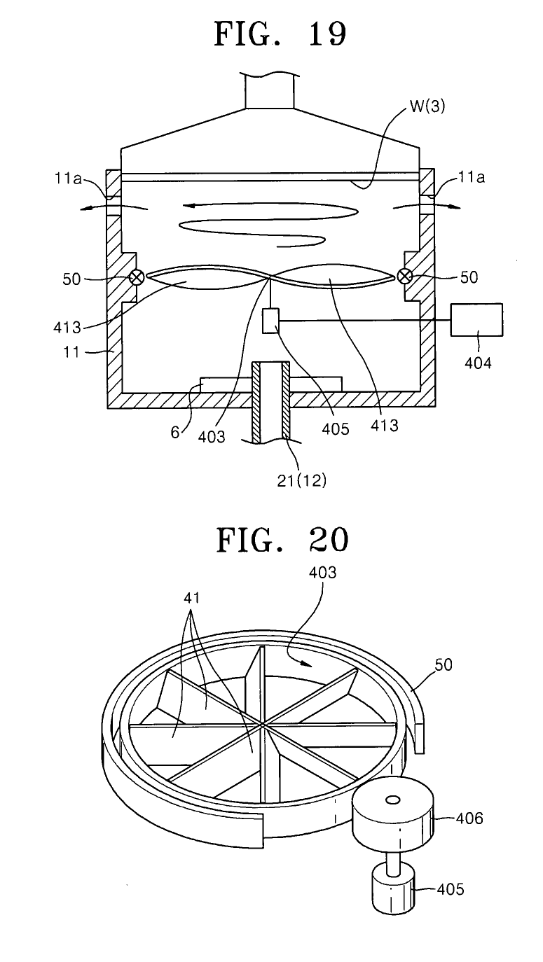

Referring to FIG. 19, semiconductor plating system according to another example embodiment of the present invention may include a motor 405 to drive a propeller 403 to rotate in response to a rotation signal output from a controller 404. Referring to FIG. 20, a rim of the propeller 403 may be connected to a rotation body 406 that rotates by the motor 405.

A rotation body 406 may be a gear (not shown) or a rotation body with a rubber contact surface. Although not shown in the drawings, a variety of power transmission systems, e.g., a pulley with a belt, may be used as the rotation body 406.

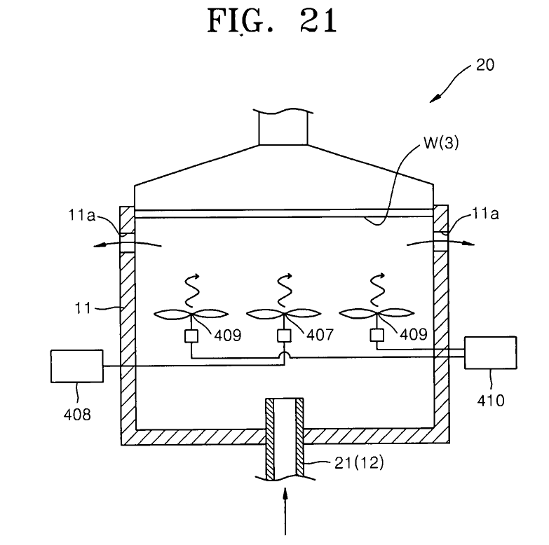

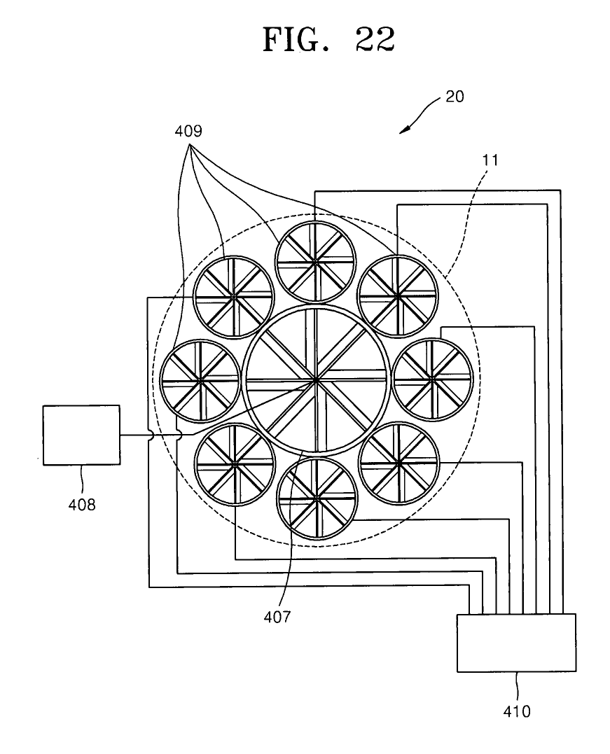

Referring to FIGS. 21 and 22, the plating solution induction device 20 may include a center propeller 407, a center propeller controller 408, a plurality of edge propellers 409, and an edge propeller controller 410. Specifically, the center propeller 407 may be installed to correspond to the center of the semiconductor object 3, and the center propeller controller 408 may apply a rotation signal to the center propeller 407. Also, the plurality of edge propellers 409 may be installed to correspond to an edge of the semiconductor object 3, and the edge propeller controller 410 may apply a rotation signal to the edge propeller 409. As can be seen from FIG. 22, the center propeller 407 may be larger than any one of the plurality of edge propellers 409.

When a measured thickness of a plate at a center of the semiconductor object 3 (e.g., the semiconductor wafer W) is greater than a measured thickness at an edge of the semiconductor wafer W, the center propeller controller 408 may apply a low-speed rotation signal to the center propeller 407 and the edge propeller controller 410 may apply a high-speed rotation signal to the edge propellers 409. As a result, a uniform plated thickness may be formed on the entire semiconductor wafer W. Namely, the center propeller 407 will rotate at a slower speed than the edge propellers 409, and the plating solution will increase the plated thickness at the edge of the semiconductor wafer W.

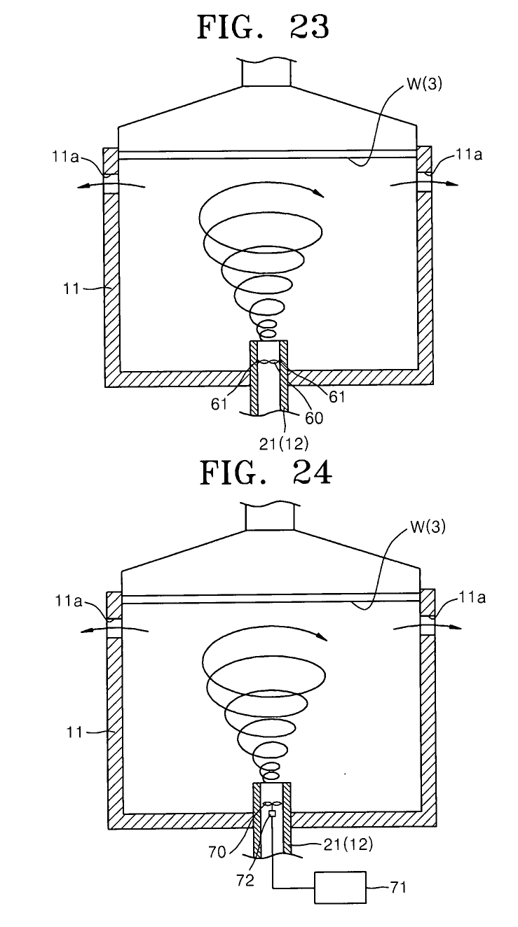

Referring to FIGS. 23 and 24, a semiconductor plating system according to example embodiments of the present invention may employ a plating solution spray nozzle 21 including a propeller 60 as the plating solution induction device 20.

Referring to FIG. 23, the propeller 60 may be installed using a bearing 61 such that the propeller 60 may be capable of rotating as a result of the flow of the plating solution 4.

Referring to FIG. 24, a motor 72 may drive a propeller 70 to rotate in response to a rotation signal output from a controller 71.

In the example embodiments illustrated in FIGS. 23 and 24, before the plating solution 4 is discharged from the plating solution supply pipe 12 or the plating solution spray nozzle 21, the plating solution 4 may be induced to spirally flow in the plating solution supply pipe 12 or the plating solution spray nozzle 21 by the propeller 60 (or 70) installed in the plating solution spray nozzle 21 prior to being supplied to the plating tank 11.

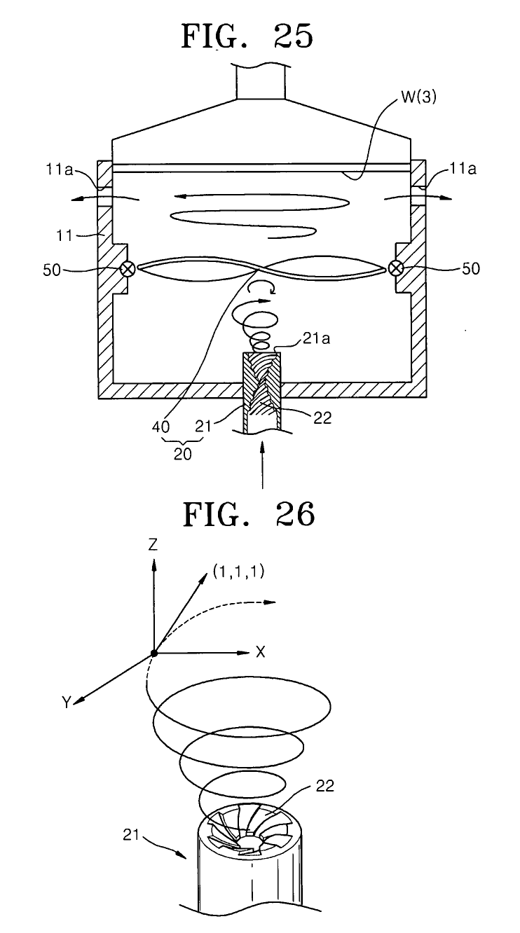

Referring to FIG. 25, a semiconductor plating system according to another example embodiment of the present invention may employ both a plating solution spray nozzle 21 and a propeller 40 as the plating solution induction device 20. In this example embodiment, the plating solution spray nozzle 21 may have a pipe shape that is arranged vertically, and may include an output orifice 21a and spiral induction protrusions 22 disposed on an inner surface of the output orifice 21a. Also, a propeller 40 may be installed over the plating solution spray nozzle 21.

The spiral flow of the plating solution 4 may be primarily induced by the plating solution spray nozzle 21 and secondarily induced by the propeller 40.

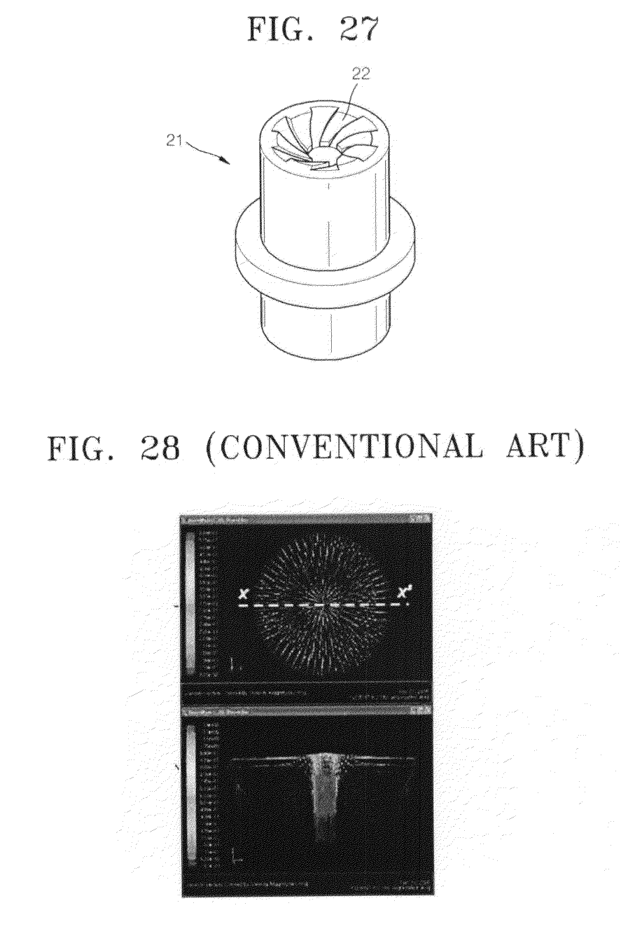

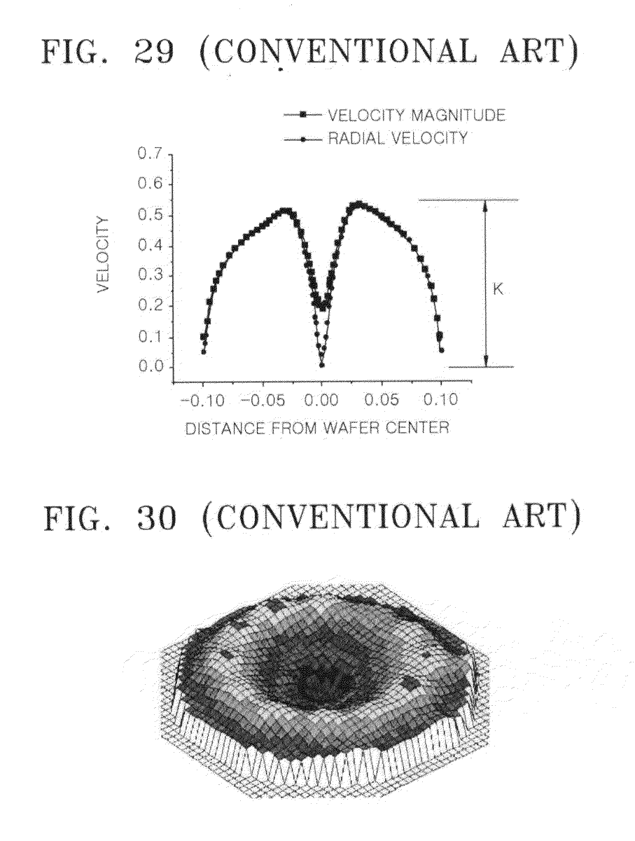

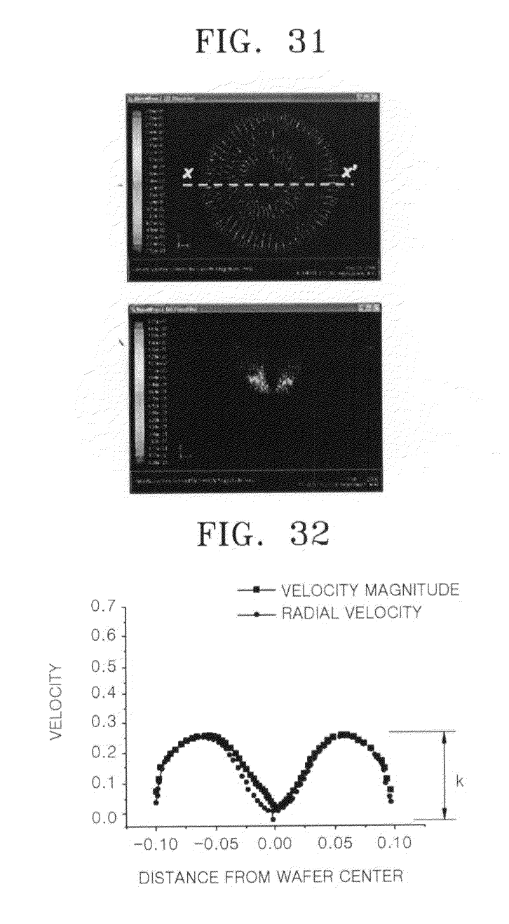

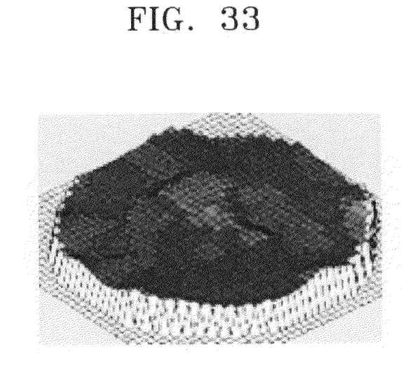

When a plating solution spray nozzle 21 as shown in FIG. 27 is used, only a little difference in the density of a plated layer may be observed between a center of a semiconductor wafer W and an edge thereof, as shown in FIG. 31. FIG. 32 is a graph illustrating a velocity of the plating solution 4 with respect to a distance from a center of the semiconductor wafer W. FIG. 32 shows a difference K between a highest velocity and a lowest velocity is approximately 0.3 meters per second. In comparison with the results of the conventional semiconductor plating system shown in FIG. 29, a difference in the velocity may be reduced by as much as 40% or more. FIG. 33 is a false color image of the thickness deviation of the plated layer formed on the semiconductor wafer W. As can be seen from FIG. 33, a plated layer has very uniform thickness as compared with the conventional semiconductor plating system shown in FIG. 30.

A flow analysis was carried out by conducting a simulation using Fluent V6.2, which is a simulation program, under laminar flow conditions by supplying water at a flow rate of 35 liters per minute. Thus, the results shown in FIG. 31 were obtained by simplifying and simulating the semiconductor plating system of FIG. 2 according to an example embodiment of the present invention.

In the above-described flow analysis as shown in FIG. 26, it may be concluded that plating solution 4 may be induced by a plating solution induction device 20 to spirally flow, and it may be most desirable that a spiral flow of the plating solution 4 approximates instantaneous velocity coordinates (1, 1, 1) in x-, y-, and z-axis directions.

The semiconductor plating systems according to example embodiments of the present invention may be applied not only to an electroplating process but also to an electroless plating process.

According to the semiconductor plating system as described above, the properties (e.g., plated thickness, shape, and roughness) of a plated layer formed on a semiconductor object may be more uniformly formed, and the semiconductor object may be fixed to a plating tank without rotation. Furthermore, the semiconductor plating system according to the example embodiments may easily induce a plating solution to spirally flow using a simple apparatus and avoid detrimentally affecting any subsequent processes.

While example embodiments have been particularly shown and described with reference to example embodiments of the present invention, it will be understood by those of ordinary skill in the art that various changes in form and details may be made therein without departing from scope of the present invention as defined by the following claims.

What is claimed is:

1. A semiconductor plating system for plating a semiconductor object, the system comprising:
a plating tank configured to accommodate a plating solution for use in plating the semiconductor object; and
a plating solution induction device configured to induce the plating solution to spirally flow toward the semiconductor object.

2. The system of claim 1, wherein the plating solution induction device comprises:
a plating solution spray nozzle having an elongated shape vertically fixed at a bottom portion of the plating tank, the plating solution spray nozzle having an output orifice, and the output orifice having spiral induction protrusions formed on an inner diameter surface thereof.

3. The system of claim 2, wherein the spiral induction protrusions include one of a square protrusion having a square section, a rounded protrusion having a rounded section, a triangular protrusion having a triangular section, a lozenge-shaped protrusion having a lozenge-shaped section, an elongated bent plate protrusion having a curvedly bent section, and a combination thereof.

4. The system of claim 2, wherein the plating solution spray nozzle comprises:
a narrowing portion having a diameter which becomes smaller along a flow direction of the plating solution to increase the pressure of the plating solution passing through the narrowing portion; and
a widening portion having a diameter which becomes larger along the flow direction of the plating solution to decrease the pressure of the plating solution passing through the widening portion.

5. The system of claim 4, wherein the diameter of each of the narrowing portion and the widening portion varies in proportion to a distance by which the plating solution flows.

6. The system of claim 4, wherein the diameter of the narrowing portion rapidly decreases and then gradually decreases, and the diameter of the widening portion rapidly increases at first and then gradually increases.

7. The system of claim 4, wherein the flow of the plating solution is controlled by adjusting a variation in the diameter of the narrowing portion and a variation in the diameter of the widening portion.

8. The system of claim 2, wherein the plating solution spray nozzle further comprises:
a spiral rod having spiral induction protrusions formed thereon.

9. The system of claim 8, wherein the plating solution spray nozzle further comprises:
an internal nozzle including spiral induction protrusions disposed on both inner and outer surfaces thereof, the internal nozzle provided concentrically between the spiral rod and the plating solution spray nozzle.

10. The system of claim 1, further comprising:
a cut-off member installed in the plating tank to partially cut off the spiral flow of the plating solution.

11. The system of claim 1, wherein the plating solution induction device comprises:
at least one propeller disposed in the plating tank.

12. The system of claim 11, wherein the at least one propeller is a motorless propeller installed in the plating tank.

13. The system of claim 11, wherein the at least one propeller is driven by a motor, the motor rotating the at least one propeller in response to a rotation signal output from a controller.

14. The system of claim 13, wherein a rim of the propeller is operationally connected to a rotation body, and the rotation body is configured for rotation by the motor.

15. The system of claim 11, wherein the plating solution induction device comprises:
a forward propeller having forward blades; and
a backward propeller having backward blades installed approximate to the forward propeller.

16. The system of claim 11, wherein the plating solution induction device comprises:
a center motorized propeller installed to correspond to a center portion of the semiconductor object;
a center propeller controller configured to rotate the center motorized propeller;
at least one edge motorized propeller installed to correspond to an edge portion of the semiconductor object; and
an edge propeller controller configured to rotate to the edge motorized propeller.

17. The system of claim 1, wherein the plating solution induction device comprised:
a plating solution spray nozzle, the plating solution spray nozzle including a propeller disposed therein.

18. The system of claim 17, wherein the propeller is a motorless propeller disposed in the plating solution spray nozzle using a bearing.

19. The system of claim 17, wherein the propeller is driven by a motor, the motor rotating the propeller in response to a rotation signal output from a controller

20. The system of claim 1, wherein the plating solution induction device comprises:
a plating solution spray nozzle having an elongated shape vertically fixed at a bottom portion of the plating tank, the plating solution spray nozzle having an output orifice, and the output orifice having spiral induction protrusions formed on an inner diameter surface thereof; and
at least one propeller installed over the plating solution spray nozzle.

21. The system of claim 1, wherein the plating solution induced by the plating solution induction device forms a spiral shape, and the spiral flow of the plating solution approximates instantaneous velocity coordinates (1, 1, 1) in x-, y-, and z-axis directions.

22. The system of claim 1, wherein the plating tank further comprises:
a wafer rotation device for rotating the semiconductor wafer.

23. The system of claim 1, wherein the plating tank comprises:
a cylindrical shape with an open top portion;
a plating solution supply pipe installed through a center of a bottom surface of the plating tank;
a plating solution outlet disposed through an upper circumferential surface of the plating tank; and
an electrode installed on an inner bottom surface of the plating tank near the plating solution supply pipe.

24. The system of claim 1, wherein the semiconductor plating system is an electroless plating system.
